(19) United States
(12) Patent Application Publication
(10) Pub. No.: US 2017/0328098 A1
(43) Pub. Date: Nov. 16, 2017

(54) DOOR STOPPER

(71) Applicant: Itshak BEN-ZION, Tel-Aviv (IL)

(72) Inventor: Itshak BEN-ZION, Tel-Aviv (IL)

(21) Appl. No.: 15/522,394

(22) PCT Filed: Sep. 27, 2015
(86) PCT No.: PCT/IL2015/050980

§ 371 Date: Apr. 27, 2017

Related U.S. Application Data
(60) Provisional application No. 62/056,380, filed on Sep. 26, 2014.

(51) Int. Cl. E05C 17/00; E05C 17/20; E05C 17/22

(52) U.S. Cl. CPC E05C 17/025; E05C 17/22; E05C 17/203; E05Y 2201/218; E05Y 2900/132; E05Y 2900/148; E05Y 2201/244

(57) ABSTRACT

A stopper for stopping rotation of a planar element with respect to a frame when the planar element is hinged to the frame, the stopper has a longitudinal axis and comprises: a locking bar having a toothed surface and received within an indentation, an operation handle for moving the locking bar out of the indentation, a locking spring having a locking tooth that is urged into the toothed surface, a releasing lever for releasing the locking tooth from the toothed surface, a retention spring for urging the locking bar into the indentation. A linear movement of the operation handle moves a portion of the locking bar out of the indentation, the locking bar abuts against the frame, and, the locking bar is fixed in its position by means of the locking tooth that is urged against the toothed surface.

### FIELD OF THE INVENTION

The present invention relates to the field of stoppers for doors and wing windows, and more particularly to the field of stoppers that keep the door or window open at any desired opening.

### BACKGROUND OF THE INVENTION

Door stoppers are known. The purpose of a door stopper is to hold a door in a fully opened position or to prevent it from closing and slamming The simplest way of achieving it is by placing a heavy object, such as a brick or the like, in front of the door, or, by placing a wooden or plastic wedge under the door. The use of a brick or weight suffers from various disadvantages. First, it is heavy to move and cannot be easily moved by handicapped people, elders, or children. Second, if it is lifted, it may fall and hurt the user. Third, it may scratch the floor when moved. Fourth, if the door is moved away therefrom and slammed back against it, the lower portion of the door may be damaged.

The use of a wedge is simpler, however, it suffers from various disadvantages. First, the user has to bend to the floor, Second, the user has to hold the wedge, either for inserting it under the door or for pulling it away from the door. Third, the user has to slightly push the wedge against the door in order to guarantee that the wedge is wedged between the door and the floor, otherwise, the wedge will not be wedged and the door may push and move the wedge.

Other door stoppers comprise wedges or stoppers that are attached to the floor by a screw that passes therethrough. Despite the fact that these stoppers may be used without making any changes in the door, they suffer from the following disadvantages. First, they require to drill into the floor. Second, the doors are stopped always in the same fixed position and cannot be stopped at any other point. Third, the stopper that is attached to the floor interferes to the cleaning of the floor in that area.

A similar kind of stoppers comprise various types of male/female devices. One part of the device is attached to a rear portion of the door and the other part of the device is attached to the floor or to the wall. These devices suffer from the same disadvantages as the formerly described stoppers, and furthermore, they may require; (a) to drill in the wall, (b) to leave a permanent part attached to the wall, thus disturbing passage and cleaning, (c) exact mutual positioning of both parts for providing proper engagement therebetween.

CN202866485(U) discloses a door with a door stopper. It comprises a door body and a door frame. The sides of the door frame and the door body, which are near a rotating shaft, are both provided with a groove. The groove of the door frame is internally provided with a first spherical hinge support base and a first spherical hinge support rod which are matched with each other. The groove of the door body is provided with a second spherical hinge support base and a second spherical hinge support rod which are matched with each other.

The outer side of the first spherical hinge support rod is provided with an external thread and the second spherical hinge support rod is provided with an internal thread which is matched with the external thread of the first spherical hinge support rod. Due to the arrangement of the hidden hinge support rod on the side of the door body, the space can be saved, and the door can be effectively prevented from being closed by wind. The opening angle of the door can be adjusted randomly by adjusting the matching length of the external thread on the first hinge support rod and the internal thread on the second hinge support rod.

The door stopper of '485 suffers from the following disadvantages. First, it cannot be operable during the opening of the door, Second, the threads have to be manually engaged with each other every time the door is open and disengage every time the door needs to be closed. Third, the task of threadingly engaging the thread is time consuming and laborious. Fourth, in order to reach the same opening of the door each time, the threads have to be threaded to the exact amount every time the door is open.

CN102943599(A) discloses a door with door blocking device as described with respect to '485 and it suffers from the same disadvantages.

WO2006134618(A1) discloses an external frame for windows and doors with locking device in the opening position. More specifically, '618 discloses an external frame (1) with locking device (2) of the frame (1) in the opening position. The system includes a bolt (3) having a first portion (14) movably associated with the frame (1), and a second portion (15), transversal to the first one (14), that is movable from a first non-operating position to a second operating position.

It is engageable in a fixed element (8) for locking the frame (1) in the opening position by means of at least a translational movement or at least a rotation movement relative to the frame (1) itself. The first portion (14) of the bolt (3) is preferably integrated in the internal edge (4) of the frame (1).

The '618 suffers from various disadvantages. First, it cannot stop the opening of the door at any desired position but only in the fully opened position. Second, the operation of the lock requires three consecutive actions: (a) disengaging the working leg 8 out of its catch of two ear-like detents 19, (b) pulling the guided leg 7 linearly outwardly, and, (c) rotating the working leg 8 to its final position for holding the frame in the opened position.

FR2495676(A1) discloses a door stopper that locks the door in a fully opened position by rotating an handle that abuts against the frame. Similar to stoppers described above, the stopper of '676 cannot stop the door at any desired position but only in a fully opened position.

GB23573 6(A) to Laporta discloses a door or window stop. A door assembly (10) comprises a door (12) hingedly mounted on a frame (14). The assembly includes a door stop mechanism (18) acting between the rear edge (23) of the door and the adjacent frame member, for holding the door in a predetermined open position. The stop mechanism (18) comprises a hook (30) mounted on the door and engageable with a spigot (38) mounted on the frame. When the door is closed, the door stop mechanism (18) is substantially concealed from view. The spigot (38) is received in a recess (42) to act as a security dead-bolt.

The '316 stop suffers from various disadvantages. First, in order to lock the door (12) in position, the hook (30) has to be engaged over the spigot (38). Second, the door can be hold only in a predetermined open position.

DE102007015130(A1) discloses a door stop. The door stop has a stop device with a bar (6) and a bar support (1), where the bar is displaceably fastened relative to the bar support in different positions. The bar support has a section (3) for arrangement at a long side of a door leaf (2) and a section (4) for arrangement at a door edge transverse to a long side of the door leaf. The sections are arranged in a right angle to each other. A retainer cavity (5) is provided for the bar at the section (3), and an appropriate internal thread is provided in the retainer cavity.

The '130 stop suffers from various disadvantages. First, the bar support has to fit two transverse sides of the door. Second, the extension of the bar is pre-determined according to the position of the bar relative to the thread, and if other opening of the door is wanted, it is require to manually rotate and adjust a new position of the bar relative to the bar support.

CZ9402818(A3) discloses an adjusting spacer, particularly for doors and windows. The spacer consists of a guide tube (1) with attachment opening (11) and having inside slidably mounted a rod-like guide (2) with slots (3). The attachment opening (11) communicates with a shaped securing element (5). On the guide tube (1) there are performed shoulders (8) between which an opening (9) of rectangular form is made. On the guide tube (1) there is rotatably mounted an adjusting member (4) in a cavity (10) of which the shaped securing element (5) is slidably mounted via a resilient element (6). Said shaped securing element (5) having counter slots (7) is at the same time mounted between said guide tube (1) shoulders (8) and in said guide tube (1) the rod-like guide (2) with slots (3) is slidably mounted.

The '818 suffers from the disadvantage that the counter slots (7) of the securing element (5) have to be manually disengaged from the slots (3) of the rod-like guide (2) each time it is desired to set the extension of the rod-like guide (2) with respect to the guide tube (1), or, each time it is desired to re-set said extension.

It is the object of the present invention to provide a door stop that significantly reduces or overcomes the aforementioned disadvantages.

It is a further object of the present invention to provide a door stop that can be used as a wing window stop.

It is still a further object of the present invention to provide a door stop that may be adjusted to stop a door or a wing window at any desired position.

It is still yet a further object of the present invention to provide a door stop that is easily extended to any desired position.

It is also a further object of the present invention to provide a door stop that is easily retracted from any extended position.

It is another object of the present invention to provide a door stop that may be installed on the door or may be concealed therein.

It is still yet another object of the present invention to provide a door stop that is effective in any relative position of the door relative to the door frame.

It is still further another object of the present invention to provide a door stop that may me set to any desired position in a single movement.

It is also another object of the present invention to provide a door stop that may be released from any desired position in a single movement.

### SUMMARY OF THE INVENTION

In accordance with the present invention there is provided a stopper for stopping rotation of a planar element with respect to a frame when the planar element is hinged to the frame, the stopper having a longitudinal axis and comprises:

a locking bar having a toothed surface and received within an indentation,

an operating handle for moving the locking bar out of the indentation,

a locking spring having a locking tooth that is urged into the toothed surface,

a releasing lever for releasing the locking tooth from the toothed surface,

a retention spring for urging the locking bar into the indentation, wherein;
linear movement of the operation handle moves a portion of the locking bar out of the indentation, the locking bar abuts against the frame, and, the locking bar is fixed in its position by means of the locking tooth that is urged against the toothed surface,

Advantageously, the stopper is retracted into the indentation by means of a linear movement of the releasing lever.

In some embodiments, the stopper is provided with a spring elevating mechanism, and wherein elevation of the elevating mechanism disengages the locking tooth from the toothed surface.

If desired, the spring elevating mechanism comprises a cam that is rotatable with respect to a cam axis, the cam comprises a round portion and a. flat portion, and wherein

when the locking spring abuts the flat portion the locking tooth locks the toothed surface, and

when the locking spring abuts the round portion the locking tooth disengages from the toothed surface.

Advantageously, the locking spring is brought into abutment with the round portion of the cam by means of linear movement of the releasing lever.

If desired, the locking spring is brought into abutment with the round portion of the cam by means of circular movement of the cam.

According to some embodiments, the retention spring is a tension spring.

According to other embodiments, the retention spring is a compression spring.

Practically, the stopper is a door stopper.

Further practically, the stopper is a wing window stopper.

Typically, the stopper is installed concealed within the planar element.

If desired, the stopper is installed on an outer surface of the planar element.

Typically, the stopper is installed parallel to an outer surface of the planar element.

If desired, the stopper is installed slanted with respect to an outer surface of the planar element.

Further if desired, the locking bar moves in an arcuate movement.

In some embodiments, a forward portion of the locking bar is provided with a sideward extending mechanism, and

in an extended position of the sideward extending mechanism, a portion of the sideward extending mechanism abuts the door frame even if a longitudinal axis of the locking bar does not cross the door frame.

If desired, a front edge of the sideward extending mechanism is provided with a contact edge.

Further if desired, a front edge of the locking bar is provided with a contact edge.

### BRIEF DESCRIPTION OF THE DRAWINGS

For a better understanding of the present invention and to show how the same may be carried out in practice, reference will now be made to the accompanying drawings, in which:

FIG. 1 is an exploded perspective view of a door stopper according to a first embodiment of the present invention;

FIG. 2 is a side cross-sectional view of the door stopper of FIG. 1 in a retracted position;

FIG. 3 is a side view of the door stopper of FIG. 1 in a retracted position;

FIG. 4 is a front view of the door stopper of FIG. 3;

FIG. 5 is a side cross-sectional view of the door stopper of FIG. 1 in an extended position;

FIG. 6 is a side view of the door stopper of FIG. 1 in an extended position;

FIG. 7 is a front view of the door stopper of FIG. 6;

FIG. 8 is a top cross-sectional schematical view of a door stopper according to the present invention in an extended position against a door frame;

FIG. 9 is a front view of a second embodiment of a door stopper according to the present invention;

FIG. 10 is a side cross-sectional view of the door stopper of FIG. 9 in a retracted position;

FIG. 11 is a side cross-sectional view of the door stopper of FIG. 10 in an extended position;

FIG. 12 is an enlarged side cross-sectional view of the locking and releasing mechanism of FIG. 10 in a locking position;

FIG. 13 is an enlarged side cross-sectional view of the locking and releasing mechanism of FIG. 10 in a releasing position;

FIG. 14 is a top view of a modified embodiment of a door stopper according to the present invention in a retracted position; and

FIG. 15 is a top view of the door stopper of FIG. 14 in an extended position.

### DESCRIPTION OF PREFERRED EMBODIMENTS

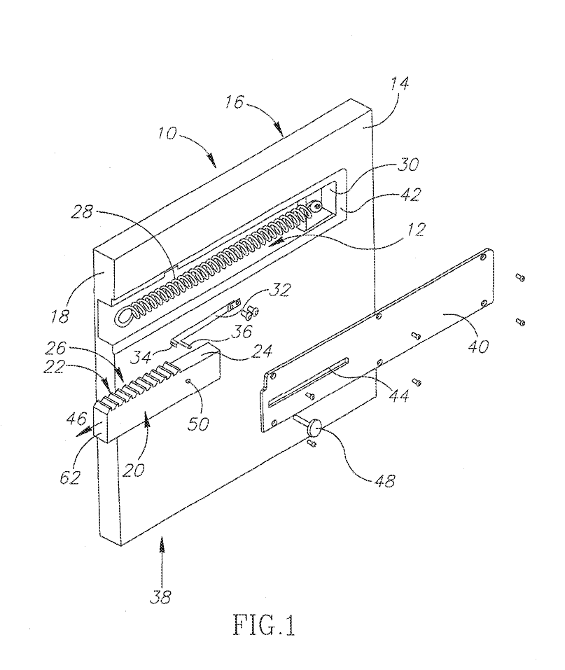

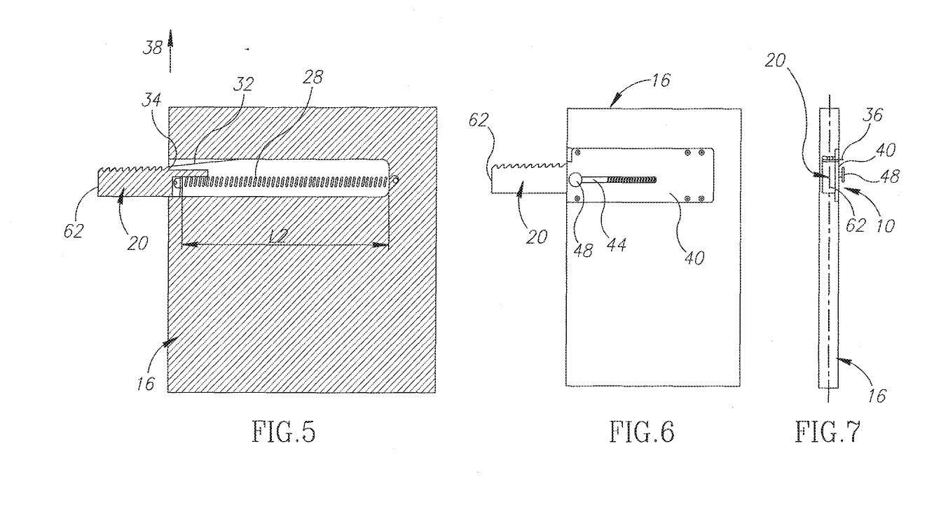

Attention is first drawn to FIGS. 1 to 7 that show a door stopper 10 according to a first embodiment of the present invention. The door stopper 10 is received within an indentation 12 formed at a door front face 14 of a door 16, wherein only a portion of the door 16 is shown in the figures. The indentation 12 extends along the door front face 14 and opens into a door side face 18.

It should be noted that directional terms appearing throughout the specification and claims, e.g. “forward”, “rear”, “upper”, “lower” etc., are used as terms of convenience to distinguish the location of various surfaces relative to each other. These terms are defined with reference to the figures, however, they are used for illustrative purposes only, and are not intended to limit the scope of the appended claims.

The door stopper 10 comprises a locking liar 20 that has a rectangular cross-section and may freely slide within the indentation 12. A front portion 22 of a locking bar upper surface 24 is provided with upwardly extending and rearwardly directed teeth 26.

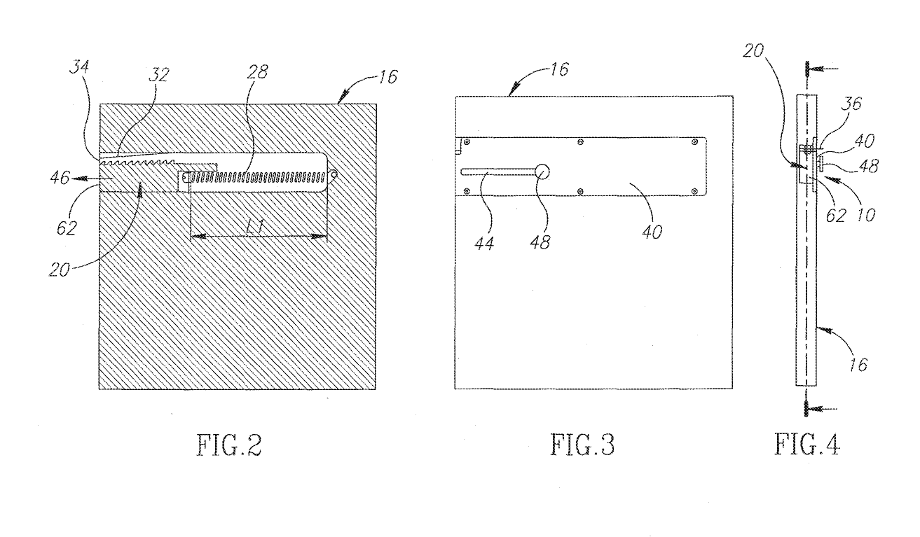

A retention spring 28 is located between the locking bar 20 and a rear end 30 of the indentation 12. The retention spring 28 is attached, at a rear end thereof, to the rear end 30 of the indentation 12. A forward end of the retention spring 28 is attached to a rear end of the locking bar 20 or, as seen in FIGS. 2 and 5, adjacent a rear end of the locking bar 20. The retention spring 28 is a tension spring, i.e., when it is not subjected to an external extending force it has a rest length L1, which is its smallest length, and when it is subjected to an external extending force it has an extended length L2 which is larger than the rest length L1.

A locking spring 32, which is a leaf spring, is attached to the indentation 12 above the locking bar 20. The locking spring 32 comprises a locking tooth 34 that extends downwardly from a front end of the locking spring 32, and, a releasing lever 36 that extends outwardly from the locking spring 32, perpendicularly thereto, and away from the door front face 14.

The locking spring 32 is urged such that the locking tooth 34 is urged downwardly, into the teeth 26 of the locking bar 20, and, an upward motion 38 acting on the releasing lever 36 disengages the locking tooth 34 from the teeth 26 of the locking bar 20.

A cover 40 is attached to a cover groove 42 that is formed around the indentation 12. The cover 40 is provided with a handle slot 44 that extends parallel to the indentation 12 and the locking bar 20 in an operating direction 46 of the door stopper 10. An operating handle 48 passes through the handle slot 44 and threadingly engages into a corresponding threaded bore 50 formed in a side face of the locking bar 20.

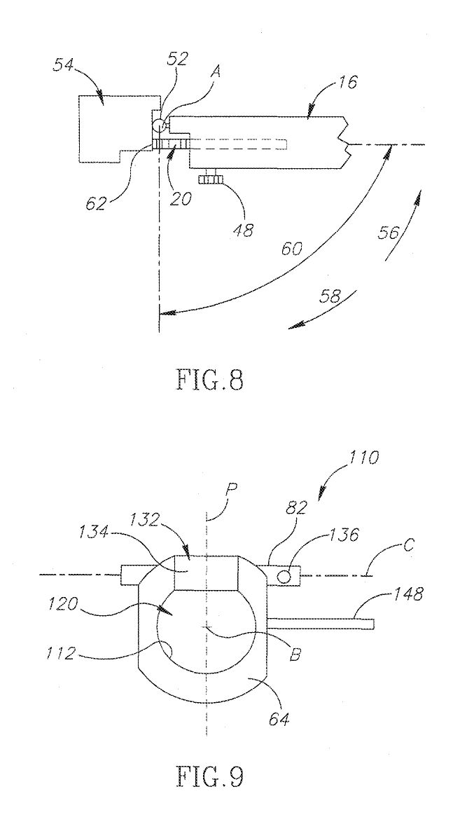

The operation of the door stopper 10 will now be described. As shown in FIG. 8, the door 16 is rotatable with respect to a hinge 52, having a hinge axis A, which is connected to a door frame 54. The door 16 may be rotated with respect to the door frame 54 in a door opening direction 56, as shown by the counter-clockwise directed arrow, or, in a door closing direction 58, as shown by the clockwise directed arrow. In FIG. 8, the door 16 is shown opened to a 90 degrees opening angle 60 with respect to the door frame 54, however, any other opening angle 60, even larger than 90 degrees, is applicable as well.

When the door 16 reaches its desired opening with respect to the door frame 54, the operating handle 48 is moved in the operating direction 46. In this position, the locking bar 20 is urged forwardly in the operating direction 46 against the rearwardly pulling force acting thereon by the retention spring 28. Since the teeth 26 of the locking bar 20 are rearwardly directed, the downwardly urged locking tooth 34 of the locking spring 32 is pushed upwardly by each of the teeth 26 and slides thereon, thus enabling free slide of the locking bar 20 with respect to the locking tooth 34 when the locking bar 20 moves in the operating direction 46.

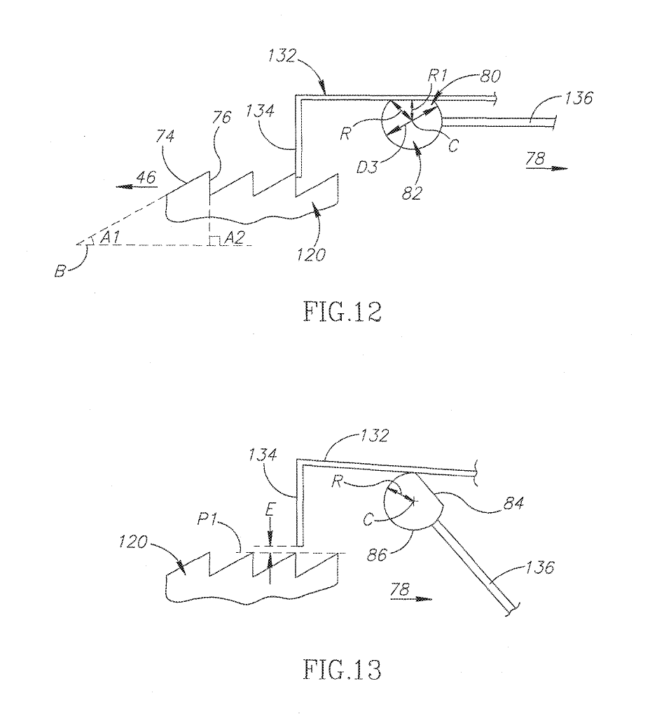

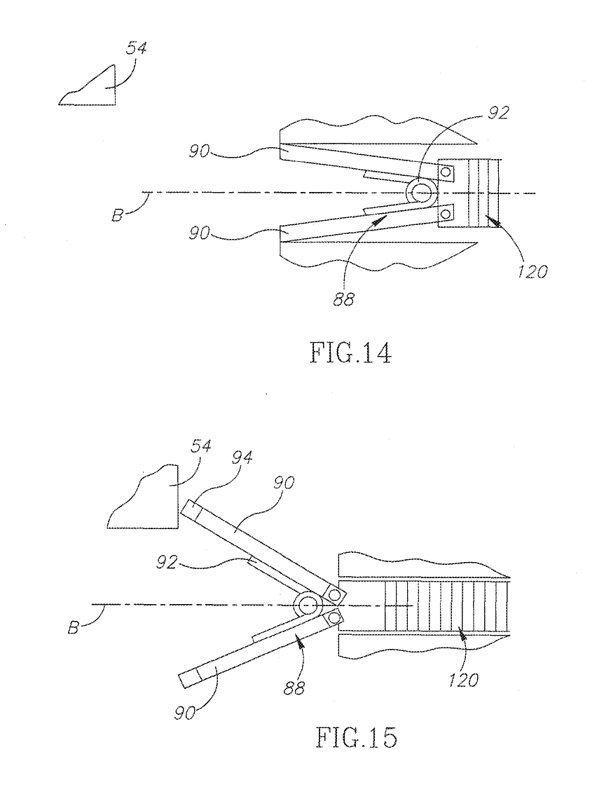

The locking bar 20 is moved until a locking bar front end 62 abuts against any portion of the door frame 54. In this position, the door stopper 10 is locked thus holding the door 16 in its position with respect to the door frame 54. The locking bar 20 cannot freely slide back into the indentation 12 since the locking tooth 34 is urged downwardly by the locking spring 32 and prevents back movement of the teeth 26 (as will be better specifically described with respect to FIGS. 12 and 13).

As can be understood by a person skilled in the art, the operation of the door stopper 10 is very simple and useful. It requires only one linear movement, without needing to concentrate in accuracy nor in sight ability of the user, such as in prior-art systems that require more complicated tasks to be carried out by the user.

Since the door stopper 10 does not require any specific adjustment by the user, the operating handle 48 is simply linearly moved until the locking bar 20 is stopped by an adjacent door frame 54. Thereby, the door stopper 10 according to the present invention is not limited to be used with a fully opened door only, and it is equally applicable for any opening angle 60 of the door 16 with respect to the door frame 54. Thus, as explained above, with any angle of opening of the door 16 with respect to the door frame 54, the locking bar 20 will abut against the door frame 54, the locking bar 20 is prevented from withdrawing back into the indentation 12 by means of the locking tooth 34, and, the door 16 is prevented from being closed to a smaller opening angle 60 than the opening angle 60 on which it is stopped by the door stopper 10.

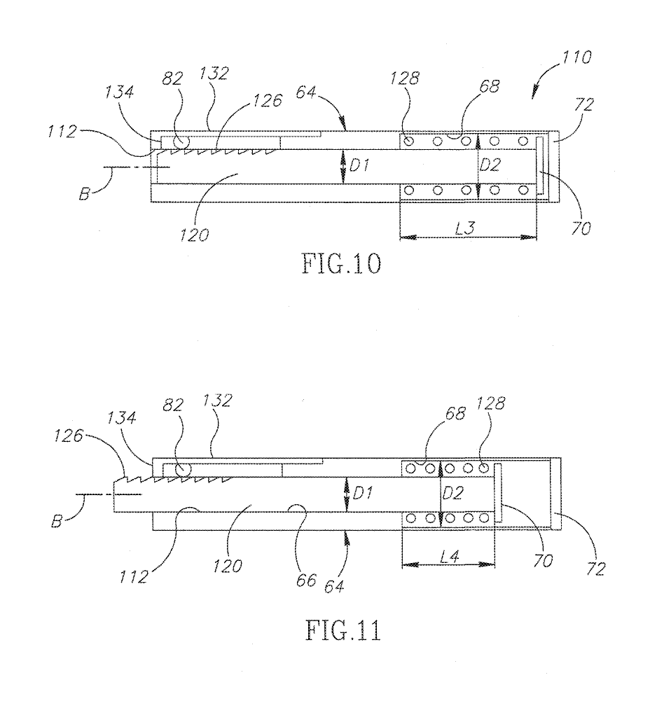

Reference is now made to FIGS. 9 to 13 that show another embodiment of a door stopper 110 according to the present invention. In general, like parts will be marked with like reference numerals with the addition of 100.

The door stopper 110 comprises a locking bar 120 that is provided within an indentation 112 in a housing 64. The indentation 112 is in the form of a cylindrical bore 66, having a first diameter D1, which is adapted to receive a corresponding cylindrical shape of the locking bar 120.

A rear portion of the indentation 112 comprises a spring receiving portion 68 having a second diameter D2 that is larger than the first diameter D1. A retention spring 128 is assembled over a rear portion of the locking bar 120 and is located within the spring receiving portion 68.

The retention spring 128 of the door stopper 110 is a compression spring and it is limited in a rear portion thereof by a rear stopper 70 that is attached to the locking bar 120. When the retention spring 128 is not subjected to an external compressing force it has a rest length L3, which is its largest length, and when it is subjected to an external compressing force it has a compressed length L4 which is smaller than the rest length 13.

A rear end of the housing 64 that serves as an assembling aperture to various components of the door stopper 110 is provided with a rear cover 72 that is attached to the housing 64 typically by a mutual thread.

A front portion of the locking bar 120 is provided with teeth 126 that are similar to the teeth 26 described above with respect to the first embodiment of the door stopper 10. The multitude of teeth 126 are perpendicular to a longitudinal axis B of the locking bar 120. The teeth 126 are formed in an upper and flat portion of the locking liar 120. The teeth 126 are upwardly directed and rearwardly slanted.

A tooth front wall 74 of each of the teeth 126 is slanted at a first inclination angle Al with respect to the longitudinal axis B. A tooth rear wall 76 of each of the teeth 126 is slanted at a second inclination angle A2 with respect to the longitudinal axis B. According to a specific embodiment of the locking bar 120, the first inclination angle A1 is 30 degrees, and, the second inclination angle A2 is 90 degrees.

A locking spring 132 having a downwardly directed locking tooth 134 is attached to an upper front portion of the housing 64. When the locking bar 120 is moved in an operating direction 146, by means of an operating handle 148 in a similar manner as described above, the locking tooth 134 slides on the tooth front wall 74 of each of the teeth 126 thus free slide of the locking bar 120 with respect to the housing 64 is enabled in the operating direction 146. However, when the locking bar 120 is urged to move in a retracting direction 78, which is opposite to the operating direction 46, the downwardly urged locking tooth 134 of the locking spring 132 abuts against a tooth rear wall 76 thus preventing movement of the locking bar 120 in a retracting direction 78.

When it is desired to move the locking bar 120 in the retracting direction 78, the locking spring 132 is elevated above the locking bar 120 by means of a spring elevating mechanism 80. The spring elevating mechanism 80 comprises a cam 82 that is rotatable with respect to a cam axis C that is perpendicular to the longitudinal axis B, and perpendicular to a median plane P that passes through the longitudinal axis B and bisects the locking spring 132.

The cam 82 comprises a flat portion 84, and, a round portion 86 having a radius R. The flat portion 84 is distanced from the cam axis C a rest distance R1 that is smaller than the radius R. In a non-retracting position, i.e., in a locking position, of the cam 82, the locking spring 132 rests on the flat portion 84 of the cam 82, as shown in FIG. 12.

When it is required to close the door 16 with respect to the door frame 54, the locking bar 120 has to be moved in the retracting direction 78. For that purpose, the locking tooth 134 has to be separated from the tooth rear wall 76 that is currently abutting, and be elevated a releasing distance E from a reference plane P1 that passed through an uppermost edge of the teeth 126.

The elevation of the locking tooth 134 may be carried out in two options. According to a first option, the cam 82 is rotated with respect to the cam axis C a given rotation angle. This action brings the can 82 from the position shown in FIG. 12, in which the locking spring 132 is distanced a rest distance R1 from the cam axis C, to the position shown in FIG. 13, in which the locking spring 132 is distanced a radius R from the cam axis C.

Since the radius R is larger than the rest distance R1, the locking spring 132 is urged upwardly until the locking tooth 134 releases its engagement with the tooth rear wall 76 and is distanced a releasing distance E from the reference plane P1. In this position, the retention spring 128 that was compressed to the compressed length L4 expands rearwardly until it reaches its rest length L3 thus retracting the locking bar 120 into the housing 64 in the retracting direction 78. It should be understood that the cam 82 may be rotated to either direction, i.e., clockwise or counter-clockwise, in order to release the locking tooth 134 from the locking bar 120.

According to a second option, the cam 82 may be rotated by a releasing lever 136 that is connected to the cam 82 substantially parallel to the longitudinal axis B. The releasing lever 136 may be positioned at a front side of the cam 82 or at a rear side of the cam 82. For that reason, the releasing lever 136 shown in FIG. 9 is shown extending forwardly from the cam 82 and the releasing lever 136 shown in FIGS. 12 and 13 is shown extending rearwardly from the cam 82.

Since the releasing lever 136 is much larger than a can diameter D3, its operation is actually a linear movement in a direction that is substantially perpendicular to a radial direction passing along the releasing lever 136. Practically, even a small upward or downward movement applied to a free edge of the releasing lever 136 is enough for releasing the locking tooth 134 from the locking bar 120 thus enabling easy retraction of the locking bar 120 into the housing 64.

FIGS. 14 and 15 show a modified embodiment of the invention that is used when in an opened position of the door 16 the longitudinal axis B is not crossing the door frame 54. For that purpose, a front portion of the locking bar 120 is provided with a sideward extending mechanism 88. The sideward extending mechanism 88 comprises two wings 90. Each of the wings 90 is hinged to a front portion of the locking bar 120. A torsion spring 92 is attached to an inner portion of the wings 90 for urging the wings 90 away from each other.

In a retracted position of the door stopper 110, the sideward extending mechanism 88 is received within the indentation 112, the torsion spring 92 is compressed, and the wings 90 are in a folded position. In an extended position of the door stopper 110, the sideward extending mechanism 88 is released from the indentation 112, the torsion spring 92 is released, and the wings 90 are maximally distanced away from each other. Thus, as shown in FIG. 15, even though the longitudinal axis B does not cross any portion of the door frame 54, in an extended position of the sideward extending mechanism 88, at least a portion of the sideward extending mechanism 88, i.e., a wing 90 in this case, abuts against the door frame 54 thus locking the door 16 in its position with respect to the door frame 54.

In some embodiments, a forward end of the wings 90 is provided with a. contact edge 94 that is made of a relatively soft material such as rubber or the like. The contact edge 94 provides two purposes. First, preventing damage to the door frame 54 by the door stopper 110. Second, better grip of the wing 90 against the door frame 54 thus providing better stability of the position of the door stopper 110 with respect to the door frame 54, Similarly, a forward end of the locking bars 20, 120 may be provided with a contact edge, mutatis mutandis.

Although the present invention has been described to a certain degree of particularity, it should be understood that various alterations and modifications could be made without departing from the spirit or scope of the invention as hereinafter claimed.

For example, the door stop does not have to be concealed and located within an indentation in the side of a door. Alternatively, the door stop can be assembled directly on the face of a door. In this position, despite the fact that it is more conspicuous, it requires no special preparations on the door prior to installation. In that case, it may be fastened to the door by means of screws, fasteners, rivets, glue, or any other appropriate manner.

The door stop may be installed directly into the indentation formed in the door front face, or, it may be installed within a housing that is installed into the indentation.

The door stopper according to the present invention is not limited to be used manually. According to other embodiments, the door stopper may be remotely used electrically or pneumatically, providing that appropriate operating devices are added to the system, mutatis mutandis.

The sideward extending mechanism shown in FIGS. 14 and 15 is shown as a schematical representation only of any mechanism that enables sideways movement for engaging into the door frame.

According to some embodiments, the locking bar extends outwardly from the housing in a sideward directed circular movement or in a sideward directed linear movement.

The door stopper does not have to be positioned parallel to the door front face and it may be positioned slanted with respect thereto.

Even though the stopper has been described with respect to a door that is prevented from closing with respect to a door frame, the stopper according to the present invention is equally applicable for being used with wing windows. In general, the stopper according to the present invention prevents closing of a planar element with respect to a frame that the planar element is hinged thereto.

Even though the position of the door stopper with respect to the floor has not been discussed, it may be positioned in any height which is convenient is a specific case. Thus, according to various embodiments, the door stopper according to the present invention is positioned close to the floor, or, in a middle height portion of the door, or, at an upper portion of the door.

The cross-section of the locking bar may be round, rectangular, square, hexagonal, or any other appropriate shape.

The door stopper according to the present invention may be formed from various different materials to suit various needs and price ranges. Thus, the door stopper may be formed from metals, such as steel, stainless steel, brass, aluminium and the like, or, from plastic or polymeric materials, including the springs and the locking bars.

The door stopper is not limited for being used with vertically positioned doors or wing windows, and it may be used also with doors or wing windows that are slanted with respect to a plane that is perpendicular to ground.

The locking bar does not have to have teeth along a single surface thereof, and it may be provided with teeth along more than one surface.

The locking tooth does not have to be directly engaged with the teeth of the locking bar. In some embodiments, the locking tooth ends with a roll that rolls on the teeth thus preventing wear of the teeth and of the locking tooth.

1. A stopper (10, 110) for stopping rotation of a planar element (16) with respect to a frame (54) when the planar element is hinged to the frame, the stopper having a longitudinal axis (B) and comprises:
a locking bar (20, 120) having a toothed surface (26, 126) and received within an indentation (12, 112),
an operating handle (48, 148) for moving the locking bar out of the indentation,
a locking spring (32, 132) having a locking tooth (34, 134) that is urged. into the toothed surface,
a releasing lever (36, 136) for releasing the locking tooth from the toothed surface,
a retention spring (28, 128) for urging the locking bar into the indentation, wherein;
linear movement of the operation handle moves a portion of the locking bar out of the indentation, the locking bar abuts against the frame, and, the locking bar is fixed in its position by means of the locking tooth that is urged against the toothed surface.

2. The stopper (10, 110) according to claim 1, wherein:
the stopper is retracted into the indentation by means of a linear movement of the releasing lever.

3. The stopper (110) according to claim 1, wherein:
the stopper is provided with a spring elevating mechanism (80), and wherein elevation of the elevating mechanism disengages the locking tooth from the toothed surface.

4. The stopper (110) according to claim 3, wherein:
the spring elevating mechanism comprises a cam (82) that is rotatable with respect to a cam axis (C), the cam comprises a round portion (86) and a flat portion (84), and wherein
when the locking spring abuts the flat portion the locking tooth locks the toothed surface, and
when the locking spring abuts the round portion the locking tooth disengages from the toothed surface.

5. The stopper (110) according to claim 4, wherein:
the locking spring is brought into abutment with the round portion of the cam by means of linear movement of the releasing lever.

6. The stopper (110) according to claim 4, wherein:
the locking spring is brought into abutment with the round portion of the cam by means of circular movement of the cam.

7. The stopper (10) according to claim 1, wherein:
the retention spring is a tension spring.

8. The stopper (110) according to claim 1, wherein:
the retention spring is a compression spring.

9. The stopper (10, 110) according to claim 1, wherein:
the stopper is a door stopper.

10. The stopper (10, 110) according to claim 1, wherein:
the stopper is a wing window stopper.

11. The stopper (10, 110) according to claim 1, wherein:
the stopper is installed concealed within the planar element.

12. The stopper (10, 110) according to claim 1, wherein:
the stopper is installed on an outer surface of the planar element.

13. The stopper (10, 110) according to claim 1, wherein:
the stopper is installed parallel to an outer surface of the planar element.

14. The stopper (10, 110) according to claim 1, wherein:
the stopper is installed slanted with respect to an outer surface of the planar element.

15. The stopper (10, 110) according to claim 1, wherein:
the locking bar moves in an arcuate movement.

16. The stopper (10, 110) according to claim 1, wherein:
a forward portion of the locking bar is provided with a sideward extending mechanism (88), and
in an extended position of the sideward extending mechanism, a portion of the sideward extending mechanism abuts the door frame even if a longitudinal axis of the locking bar does not cross the door frame.

17. The stopper (110) according to claim 16, wherein:
a front edge of the sideward extending mechanism is provided with a contact edge (94).

18. The stopper (10, 110) according to claim 1, wherein:
a front edge of the locking bar is provided with a contact edge (94).
